(19) United States
(12) Patent Application Publication
(10) Pub. No.: US 2013/0008163 A1
(43) Pub. Date: Jan. 10, 2013

(54) TUBULAR SOLAR RECEIVERS AND SYSTEMS USING THE SAME

(76) Inventor: Oren Michael Godot, Nes-Ziona (IL)

(21) Appl. No.: 13/575,957

(22) PCT Filed: Jan. 30, 2011
(86) PCT No.: PCT/IL11/00104

§ 371 Date: Sep. 20, 2012

Related U.S. Application Data
(60) Provisional application No. 61/299,961, filed on Jan. 30, 2010.

(51) Int. Cl. F24J 2/24; F03G 6/00

(52) U.S. Cl. 60/641.8; 126/651; 126/663

(57) ABSTRACT

A solar receiver including at least more than one tubular array, each tubular array including a tube operative to be heated by solar radiation impinging thereon, an inlet for allowing a working fluid to flow into the tube so as to be heated therein, and an outlet for allowing the heated working fluid to flow out of the tube, each tubular array being in fluid communication with a thermal energy consumption system so as to provide the working fluid to the thermal energy consumption system.

### FIELD OF THE INVENTION

The present invention relates generally to tubular solar receivers and systems using the same.

### BACKGROUND OF THE INVENTION

Solar thermal energy systems harness solar energy for generation of thermal energy. A known method for converting solar energy to thermal energy is by heating a working fluid employing solar radiation and transferring the heated working fluid to a thermal energy consumption system or apparatus. In solar thermal energy systems one device known in the art for heating the working fluid is a solar receiver. Such a receiver may utilize solar radiation which impinges upon a solar radiation absorber or conduits of the solar receiver. The working fluid is heated by the absorber or conduits, and thereafter the working fluid transfers the heat to a thermal energy consumption system or apparatus.

### SUMMARY OF THE INVENTION

There is thus provided in accordance with an embodiment of the invention a solar receiver including at least more than one tubular array, each tubular array including a tube operative to be heated by solar radiation impinging thereon, an inlet for allowing a working fluid to flow into the tube so as to be heated therein, and an outlet for allowing the heated working fluid to flow out of the tube, each tubular array being in fluid communication with a thermal energy consumption system so as to provide the working fluid to the thermal energy consumption system.

There is thus provided in accordance with another embodiment of the invention a solar receiver including at least a first and second tubular array, each tubular array including a tube operative to be heated by solar radiation impinging thereon, the tube is arranged annularly around a central longitudinal axis of the receiver, thereby defining a radius extending from the tube to the central longitudinal axis, an inlet for allowing a working fluid to flow into the tube so as to be heated therein, and an outlet for allowing the heated working fluid to flow out of the tube, at least the first and second tubular arrays are arranged such that the radius of a portion of the tube of the first tubular array is smaller than the radius of a portion of the tube of the second tubular array.

There is thus provided in accordance with yet another embodiment of the invention a solar receiver including at least a first and second tubular array, each tubular array including a tube operative to be heated by solar radiation impinging thereon, the tube is arranged annularly around a central longitudinal axis of the receiver, an inlet for allowing a working fluid to flow into the tube so as to be heated therein, and an outlet for allowing the heated working fluid to flow out of the tube, at least the first and second tubular arrays are arranged such that a portion of the tube of the first tubular array is in greater horizontal proximity to the central longitudinal axis than a portion of the tube of the second tubular array. The horizontal proximity is defined as a distance from the tube to the central longitudinal axis.

There is thus provided in accordance with still another embodiment of the invention a solar receiver including a plurality of tubular arrays, each tubular array including a tube operative to be heated by solar radiation impinging thereon, the tube is arranged annularly around a central longitudinal axis of the receiver, the solar radiation having an intensity characterized by a Gaussian-like distribution wherein the intensity is greatest at the central longitudinal axis and the intensity symmetrically recedes as a horizontal distance from the central longitudinal axis grows, an inlet for allowing a working fluid to flow into the tube so as to be heated therein, and an outlet for allowing the heated working fluid to flow out of the tube, the plurality of tubular arrays being mounted and arranged in respect to each other to define a cavity therein, wherein the cavity is configured in a Gaussian-like curvature.

There is thus provided in accordance with a further embodiment of the invention a solar receiver including at least more than one tubular array, each tubular array including a tube operative to be heated by solar radiation impinging thereon, an inlet for allowing a working fluid to flow in the tube so as to be heated therein, and an outlet for allowing the heated working fluid to flow out of the tube.

There is thus provided in accordance with yet a further embodiment of the invention a solar thermal energy system including a solar receiver including at least more than one tubular array, each tubular array includes a tube operative to be heated by solar radiation impinging thereon, an inlet for allowing a working fluid to flow in the tube so as to be heated therein, and an outlet for allowing the heated working fluid to flow out of the tube, and a plurality of thermal energy consumption systems wherein each tubular array is in fluid communication with the thermal energy consumption system so as to provide the working fluid to the thermal energy consumption system.

In accordance with an embodiment of the invention each of the tubes of at least two of the tubular arrays is formed with a different cross section diameter. Additionally, each of the tubes of at least two of the tubular arrays is formed of a different material. Moreover, a different working fluid flows in each of the tubes of at least two of the tubular arrays. Furthermore, the working fluid flows in each of the tubes of at least two of the tubular arrays at a different temperature. Additionally, the working fluid flows in each of the tubes of at least two of the tubular arrays at a different mass flow rate.

In accordance with another embodiment of the invention thermal energy of the thermal energy consumption system is provided for industrial systems or the thermal energy is utilized for vaporization or pasteurization, or the thermal energy is used for drying, or the thermal energy is used for drying polymer containing products, or the thermal energy is introduced into a vapor turbine for generation of electricity therefrom or the thermal energy is introduced into a gas turbine for generation of electricity therefrom or the thermal energy is provided to boost a vapor turbine, or the thermal energy provides steam and vapor to systems consuming vapor, or the thermal energy is utilized for direct heating of a solid desiccant system, a desiccant system included in an air conditioning system or the thermal energy is used for absorption cooling.

There is thus provided in accordance with still a further embodiment of the invention a method for heating a working fluid including introducing the working fluid into an inlet of a tubular array, and heating the working fluid within a tube of the tubular array of a solar receiver including at least more than one tubular array, each tubular array includes the tube operative to be heated by solar radiation impinging thereon, the inlet for allowing the working fluid to flow into the tube so as to be heated therein, and an outlet for allowing the heated working fluid to flow out of the tube.

There is thus provided in accordance with another embodiment of the invention a method for providing thermal energy to at least a first and second thermal energy consumption system including introducing a first working fluid into a first tube forming a first tubular array, introducing a second working fluid into a second tube forming a second tubular array, heating the first and the second tubular arrays by solar radiation impinging thereon and thereby heating the first working fluid flowing within the first tube and heating the second working fluid flowing within the second tube, the first tubular array mounted on the second tubular array and defining together a solar receiver with a central longitudinal axis, the at least first and second tubular array arranged such that a portion of the first tube of the first tubular array being in greater horizontal proximity to a portion of the central longitudinal axis than the second tube of the second tubular array, the horizontal proximity is defined as a distance from the tube to the central longitudinal axis, providing the first thermal energy consumption system with thermal energy from the heated first working fluid, and providing the second thermal energy consumption system with thermal energy from the heated second working fluid.

There is thus provided in accordance with yet another embodiment of the invention a receiver including at least more than one tubular arrays, each tubular array including a tube operative to be heated by thermal energy, an inlet for allowing a working fluid to flow in the tube so as to be heated therein, and an outlet for allowing the heated working fluid to flow out of the tube.

### BRIEF DESCRIPTION OF THE DRAWING

FIGS. 1A and 1B are a simplified pictorial illustration of a solar receiver, constructed and operative in accordance with an embodiment of the present invention and a top view thereof, respectively;

FIG. 2 is a simplified schematic illustration of the solar receiver of FIGS. 1A and 1B utilized in a solar thermal energy system, constructed and operative in accordance with an embodiment of the present invention;

FIG. 3 is a simplified schematic illustration of the solar receiver of FIGS. 1A and 1B utilized in another solar thermal energy system, constructed and operative in accordance with another embodiment of the present invention;

FIGS. 4A and 4B are a simplified pictorial illustration of a solar receiver, constructed and operative in accordance with another embodiment of the present invention and a top view thereof, respectively;

FIG. 5 is a simplified schematic illustration of the solar receiver of FIGS. 4A and 4B utilized in a solar thermal energy system, constructed and operative in accordance with an embodiment of the present invention;

FIG. 6 is a simplified schematic illustration of the solar receiver of FIGS. 4A and 4B utilized in another solar thermal energy system, constructed and operative in accordance with another embodiment of the present invention;

FIGS. 7A and 7B are a simplified pictorial illustration of a solar receiver, constructed and operative in accordance with yet another embodiment of the present invention and a top view thereof, respectively;

FIG. 8 is a simplified schematic illustration of the solar receiver of FIGS. 7A and 7B utilized in a solar thermal energy system, constructed and operative in accordance with an embodiment of the present invention;

FIG. 9 is a simplified schematic illustration of the solar receiver of FIGS. 7A and 7B utilized in another solar thermal energy system, constructed and operative in accordance with another embodiment of the present invention; and

FIG. 10 is a simplified schematic illustration of the solar receiver of FIGS. 1A and 1B utilized in still another solar thermal energy system constructed and operative in accordance with an embodiment of the present invention.

### DETAILED DESCRIPTION OF EMBODIMENTS

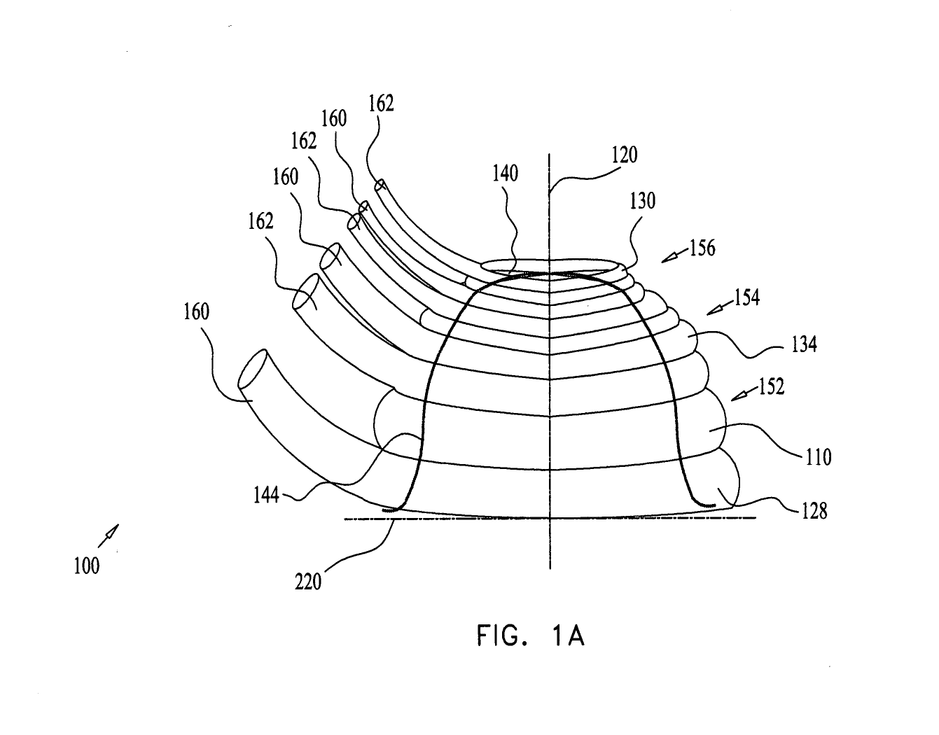

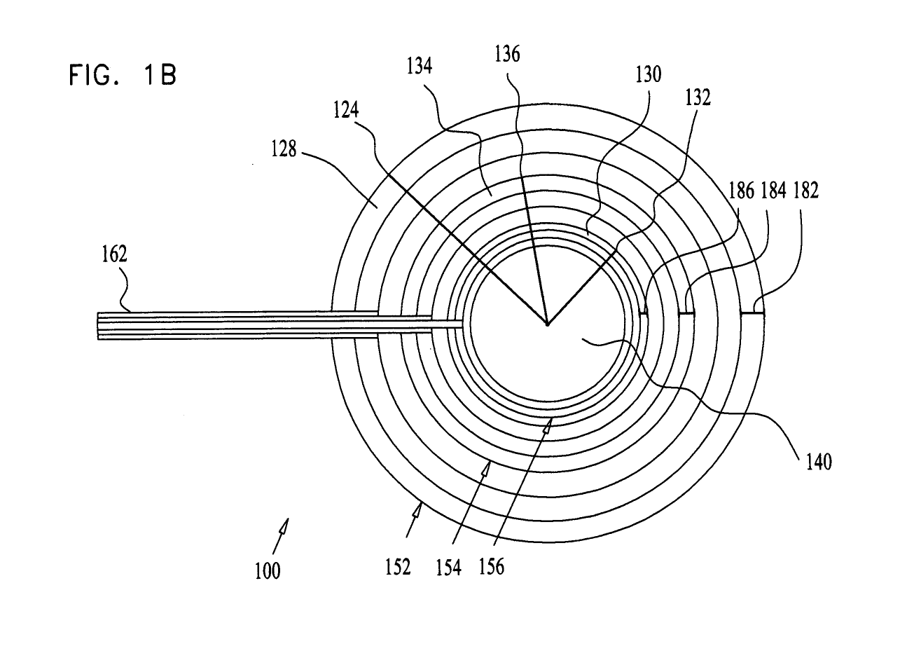

Reference is now made to FIGS. 1A and 1B, which are a simplified pictorial illustration of a solar receiver, constructed and operative in accordance with an embodiment of the present invention and a top view thereof, respectively. As seen in FIGS. 1A and 1B, a solar receiver 100 may comprise a multiplicity of tubes 110.

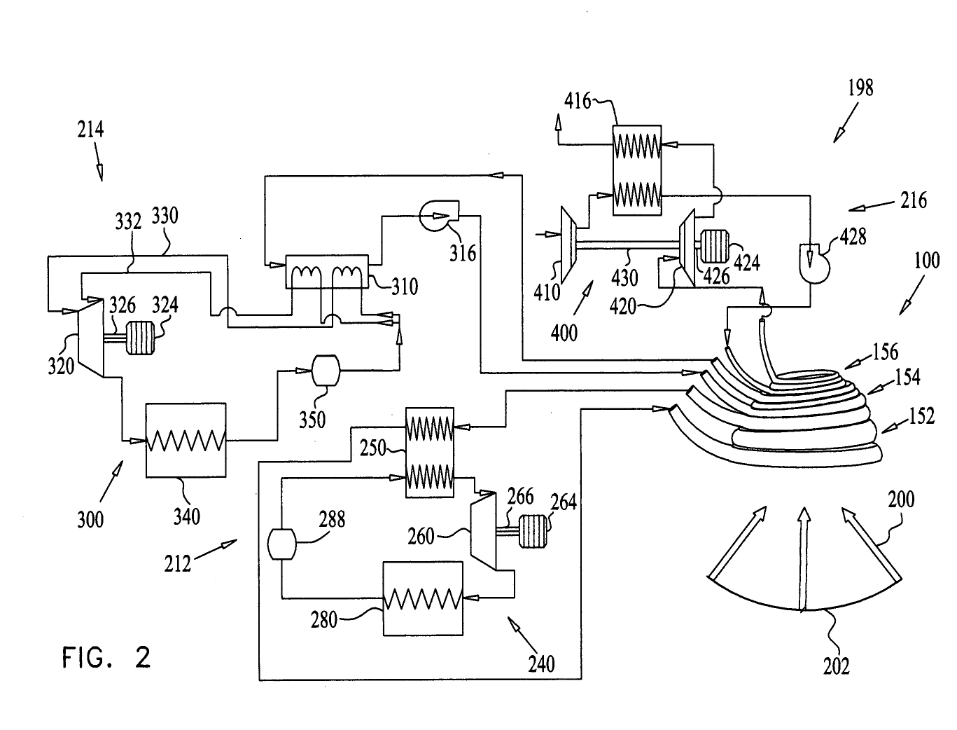

Tubes 110 may be formed in any suitable configuration. The tubes 110 may be annularly arranged around a central longitudinal axis 120. As seen in FIG. 1A, the tubes 110 are circumvolutedly mounted upon each other around the central longitudinal axis 120 wherein a base radius 124 of a surface area of tubes forming a receiver base portion 128 is greatest, while receding to a top portion 130 of the receiver wherein the top portion surface area radius 132 is smallest. The receiver 100 may be formed with an intermediate portion 134 defining an intermediate portion surface area radius 136. A cavity 140 is defined within the receiver 100 and allows solar radiation to enter therein, as will be further described in reference to FIG. 2. Cavity 140 may be formed with a Gaussian-like curvature 144 or any bell shaped curve, as schematically illustrated in FIG. 1A.

It is particular feature of the present invention that the multiplicity of tubes 110 comprises at least more than one tubular array or a plurality of tubular arrays, such as arrays 152, 154 and 156, as seen in FIG. 1A. Each tubular array may be provided with an inlet conduit 160 for allowing a working fluid therein and an outlet conduit 162 for allowing egress of the working fluid therefrom so as to allow each tubular array to be in fluid communication with a separate thermal energy consumption system, as will be further described hereinbelow with reference to FIG. 2. Each tubular array may be formed of a different material and/or a different tubular cross section diameter. For example, as seen in FIGS. 1A and 1B, the three different tubular arrays 152, 154 and 156 are shown. Tubular array 152 is located at the base portion 128 of the receiver 100. Mounted on tubular array 152 is tubular array 154 and mounted thereon is tubular array 156 at top portion 130.

In a non-limiting example, tubular array 152 may be formed of carbon steel, tubular array 154 may be formed of stainless steel and tubular array 156 may be formed of an INCONEL® comprising alloy.

Tubular array 152 is shown to have a tubular cross section 182 of a greater diameter than a diameter of a tubular cross section 184 of array 154. Similarly, the diameter of tubular cross section 184 of array 154 is greater than a diameter of a tubular cross section 186 of array 156. The difference in the tubular cross section diameter allows for a working fluid introduced into each of the tubular arrays 152, 154 and 156 to flow at a different mass flow rate. It is appreciated that some of the tubular arrays may have similar cross section diameters. For example, tubular array 152 and 154 may be formed to have the same cross section diameter while tubular array 156 may have a different cross section diameter.

Additionally, a different working fluid may be introduced into the tubular arrays 152, 154 and 156. For example, water may be introduced into tubular array 152, oil may be introduced into tubular array 154 and air may be introduced into tubular array 156. The working fluids may be each introduced into the tubular arrays 152, 154 and 156 at a different pressure and/or temperature.

It is appreciated that a plurality of tubular arrays of any configuration and diameter may form receiver 100. Alternatively, the receiver 100 may be formed of a single continuous tube with a single inlet for allowing a working fluid to flow therein. The working fluid may be heated within the single tube by solar radiation admitted within cavity 140. The heated working fluid may egress the receiver 100 from a single outlet.

Reference is now made to FIG. 2, which is a simplified schematic illustration of the solar receiver of FIGS. 1A and 1B utilized in a solar thermal energy system 198, constructed and operative in accordance with an embodiment of the present invention. As seen in FIG. 2, concentrated solar radiation 200 is introduced into the receiver 100. The solar radiation may be concentrated by any suitable means, such as by a sun-tracking concentrator or an array of sun-tracking mirrors (heliostats). For example, the sun-tracking concentrator may be a parabolic dish 202, schematically illustrated in FIG. 2. The solar radiation 200 impinges upon tubes 110 which, in turn, heat a working fluid introduced in the tubes 110. The heated working fluid egresses the tubes 110 and is introduced into a thermal energy consumption system for utilizing the thermal energy of the heated working fluid.

Each of tubular arrays 152, 154 and 156 may be in fluid communication with a different thermal energy consumption system. For example, as seen in FIG. 2, tubular array 152 is in fluid communication with a thermal energy consumption system 212, tubular array 154 is in fluid communication with a thermal energy consumption system 214 and tubular array 156 is in fluid communication with a thermal energy consumption system 216. As described hereinabove, each working fluid flowing out of each of arrays 152, 154 and 156 may flow out at a different elevated temperature and thus may be accordingly utilized in respective thermal energy consumption systems 212, 214 and 216 wherein each thermal energy consumption system requires a different fluid temperature for operation thereof.

It is known in the art that the degree of penetration of solar radiation into tubes 110 follows a Gaussian-like distribution. In other words, as a horizontal distance from the longitudinal axis 120, along a horizontal axis 220 (FIG. 1A), increases, the solar concentration penetrating tubes 110 decreases. Namely, the solar radiation intensity is greatest at the central longitudinal axis 120 and the intensity symmetrically recedes as a horizontal distance from the central longitudinal axis 120 grows.

Accordingly, the working fluid flowing within tubes 110 is heated to a lesser degree as the horizontal distance of a tube 110 from the longitudinal axis 120 increases. Consequentially, the temperature of a working fluid flowing within a tube 110, distally located on axis 220 from longitudinal axis 120, will rise to a lesser degree than the temperature of working fluid flowing within a tube 110, proximally located on axis 220 to longitudinal axis 120.

Thus in accordance with an embodiment of the present invention the receiver 100 is configured with cavity 140 formed with the Gaussian-like curvature 144 so as to exploit the properties of the Gaussian-like distribution, as will now be described: at least a portion of the tubes of tubular array 152 are located at a greater horizontal distance to axis 120, wherein at least a portion of the tubes of tubular array 156 are located in horizontal proximity to axis 120. Thus a fluid flowing within tubular array 152 will be heated to a lesser degree than a fluid flowing within tubular array 156. Accordingly, the thermal energy consumption system 212 is preferably a thermal energy consumption system requiring less heat for operating the system 212 than the thermal energy consumption system 216, which preferably is a thermal energy consumption system requiring more heat for operating the system 216. Similarly, at least a portion of the tubes of tubular array 154 are located at a greater horizontal distance to axis 120 than at least a portion of tubes of tubular array 156 and at a lesser horizontal distance than the at least a portion of tubes of tubular array 152. Thus a fluid flowing within tubular array 154 will be heated to a lesser degree than a fluid flowing within tubular array 156 and to a greater degree than a fluid flowing within tubular array 152.

In a non-limiting example, as shown in FIG. 2, system 212 may be a system for generating vapor and electrical energy generation therefrom; system 214 may be a system for generating steam and electrical energy generation therefrom and system 216 may be a system for generating electricity by a gas turbine. It is noted that systems 212, 214 and 216 may be open or closed loop systems.

It is appreciated that any suitable system utilizing thermal energy provided by a working fluid heated within tubular arrays 152, 154 and 156 may be employed.

In system 212 the receiver 100 communicates with a vapor generating system 240. A working fluid enters the tubular array 152 of receiver 100. In a non-limiting example the incoming working fluid temperature may be approximately 100° C.

The heated working fluid exits tubular array 152 of the receiver 100 and flows to a heat exchanger 250 operative to heat an incoming vapor system working fluid, such as an organic fluid, flowing from the vapor generating system 240. In a non-limiting example, the temperature of the working fluid exiting receiver 100 is approximately 350° C., typically wherein the working fluid is air or any other gas, and the temperature of the organic fluid entering heat exchanger 250 is approximately 80° C.

The organic fluid exits the heat exchanger 250 at an elevated temperature. In a non-limiting example, the temperature of the organic fluid exiting heat exchanger 250 is approximately 300° C. The heated organic fluid flows on to an organic cycle turbine 260 which in turn drives a generator 264 via a shaft 266 for producing electrical energy therefrom.

The organic fluid, now is a state of vapor generally at near saturation point, exits the turbine 260 and flows onto a condenser 280 wherein the vapor undergoes condensation to a liquid. In a non-limiting example, the temperature of the vapor exiting steam turbine 260 is approximately 80° C. The liquid exits the condenser 280 substantiality at the temperature of the vapor entering the condenser 280, thus in a non-limiting example, the temperature of the liquid exiting condenser 280 is approximately 80° C.

The liquid exiting the condenser 280 is introduced into heat exchanger 250 via a pump 288 thereby allowing the liquid to flow continuously.

It is noted that vapor generating system 240 may be adapted to heat any suitable liquid so as to provide vapor therefrom.

In system 214, for example, the receiver 100 communicates with a steam generating system 300. A working fluid enters tubular array 154 of the receiver 100. In a non-limiting example the incoming working fluid temperature may be approximately 100° C.

The heated working fluid exits the tubular array 154 of receiver 100 and flows to a heat transfer assembly 310 operative to heat an incoming working fluid flowing from steam generating system 300. In a non-limiting example, the temperature of the working fluid exiting receiver 100 is approximately 600° C., typically wherein the working fluid is air or any other gas.

The working fluid may thereafter be re-introduced into receiver 100 so as to be re-heated thereby and to thereafter further provide thermal energy in the form of heat to the working fluid of steam generating system 300. A blower 316 may be provided to ensure the working fluid continues to flow between receiver 100 and heat transfer assembly 310.

Heat transfer assembly 310 is provided to transfer thermal energy to the working fluid of steam generating system 300 and may be any suitable device. Typically, the heat transfer assembly 310 comprises a conventional heat recovery system comprising a train of heat exchangers such as liquid pre-heaters, and/or vapor generators and/or super heaters in fluid communication therebetween, as schematically illustrated in FIG. 2. Additionally, the heat transfer assembly 310 may be a heat exchanger or any suitable device for thermal energy transfer.

The working fluid of steam generating system 300 enters heat transfer assembly 310 and is heated therein and is typically water. Generally, the water may be heated, boiled and possibly superheated in heat transfer assembly 310, generally in a plurality of stages. In a non-limiting example, the temperature of the water entering heat transfer assembly 310 is, in one of the input stages, approximately 40° C. Superheated steam exits the heat transfer assembly 310 typically at an elevated temperature. In a non-limiting example, the temperature of the steam exiting transfer assembly 310 is approximately 540° C.

The heated steam exits the heat transfer assembly 310 and flows onto a steam turbine 320 which in turn drives a generator 324 via a shaft 326 for producing electrical energy therefrom.

It is appreciated that the heat transfer assembly 310 may have a plurality of outlets, such as a first outlet 330 and a second outlet 332, flowing into steam turbine 320. Each of the plurality of outlets allows steam flowing therein to exit the heat transfer assembly 310 at a different temperature and pressure.

The steam, generally at near saturation point, exits the steam turbine 320 and flows onto a condenser 340 wherein the steam undergoes condensation to water. In a non-limiting example, the temperature of the steam exiting steam turbine 340 is approximately 40° C. The water exits the condenser 340 substantiality at the temperature of the steam entering the condenser 340, thus in a non-limiting example, the temperature of the water exiting condenser 340 is approximately 40° C.

The water exiting the condenser 340 is introduced into heat transfer assembly 310 via a pump 350 thereby allowing the water of steam generating system 300 to flow continuously.

It is noted that steam generating system 300 may be adapted to heat any suitable liquid, such as an organic liquid for example, so as to provide vapor therefrom.

In system 216, for example, the receiver 100 communicates with a gas turbine system 400.

Incoming working fluid, such as air, may be introduced into a compressor 410 operative to compress an incoming gas therein. In a non-limiting example, incoming air is generally ambient air (approximately 25° C.).

Compressed air flows out of compressor 410 typically at an elevated temperature. In a non-limiting example the air flows out of compressor 410 at a temperature of approximately 250° C. The compressed air flows onto a recuperator 416 wherein the compressed air is heated by warmer air exhausted by a gas turbine 420 at nearly atmospheric pressure, as will be further described hereinbelow. Recuperator 416 may be any suitable heat-exchanging device.

The temperature of the compressed air exiting recuperator 416 is elevated. In a non-limiting example, the temperature of the compressed air exiting recuperator 416 is approximately 590° C.

The compressed air exiting the recuperator 416 enters the tubes of tubular array 156 of the receiver 100 and is heated therein. Air exiting tubular array 156 flows into gas turbine 420, which expands the air and drives a generator 424 via a shaft 426 for producing electrical energy therefrom. In a non-limiting example, the temperature of the air exiting receiver 100 is approximately 980° C.

A blower 428 may be provided to ensure the working fluid continues to flow between recuperator 416 and receiver 100.

It is appreciated that in the embodiment shown in FIG. 2 the compressor 410 is coupled to gas turbine 420 via a coupling shaft 430 though in alternative embodiments the coupling shaft 430 may be obviated.

Expanded air exits the gas turbine 420 typically at a lowered temperature. In a non-limiting example, the temperature of the air exiting gas turbine 420 is approximately 665° C.

The expanded air enters the recuperator 416 thereby heating the compressed air entering recuperator 416 from compressor 410, as described hereinabove. The expanded air exits the recuperator 416 typically at a lowered temperature. In a non-limiting example, the temperature of the air exiting recuperator 416 is approximately 320° C. The exiting air typically flows in to the ambient.

It is appreciated that the receiver 100 may comprise a plurality of tubular arrays in communication with a plurality of thermal energy consumption systems.

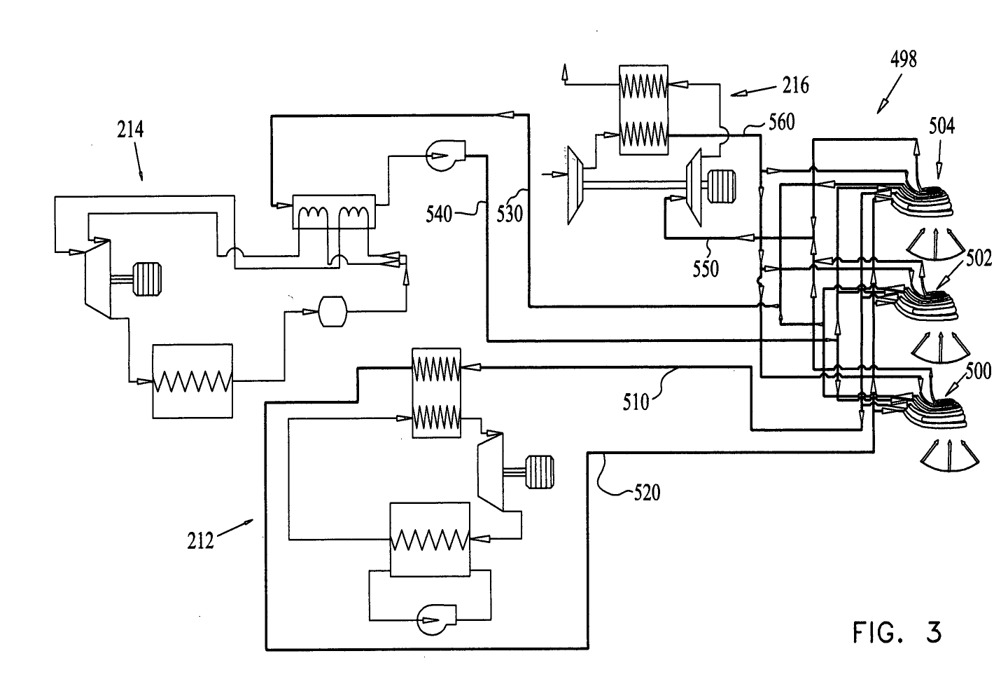

Reference is now made to FIG. 3, which is a simplified schematic illustration of the solar receiver of FIGS. 1A and 1B utilized in another solar thermal energy system 498, constructed and operative in accordance with another embodiment of the present invention. As seen in FIG. 3, solar thermal energy system 498 comprises a plurality of receivers which are each in fluid communication with systems 212, 214 and 216. In FIG. 3 three receivers are shown and designated by reference numerals 500, 502 and 504, it being appreciated that many receivers may be in fluid communication with systems 212, 214 and 216. Receivers 500, 502 and 504 may be identical to receiver 100 of FIGS. 1A-2.

Each of the tubular arrays 152 of plurality of receivers 500, 502 and 504 are in fluid communication with system 212 via a first main duct 510, operative to transfer the working fluid from each of the plurality of receivers 500, 502 and 504 to system 212, and via a second main duct 520, operative to transfer the working fluid from system 212 to tubular arrays 152 of each of the plurality of receivers 500, 502 and 504.

Each of the tubular arrays 154 of plurality of receivers 500, 502 and 504 are in fluid communication with system 214 via a first main duct 530, operative to transfer the working fluid from each of the plurality of receivers 500, 502 and 504 to system 214, and via a second main duct 540, operative to transfer the working fluid from system 214 to tubular arrays 154 of each of the plurality of receivers 500, 502 and 504.

Each the tubular arrays 156 of plurality of receivers 500, 502 and 504 are in fluid communication with system 216 via a first main duct 550, operative to transfer the working fluid from each of the plurality of receivers 500, 502 and 504 to system 216, and via a second main duct 560, operative to transfer the working fluid from system 216 to tubular arrays 156 of each of the plurality of receivers 500, 502 and 504.

It is appreciated that the plurality of receivers may be in fluid communication with any suitable thermal energy consumption system.

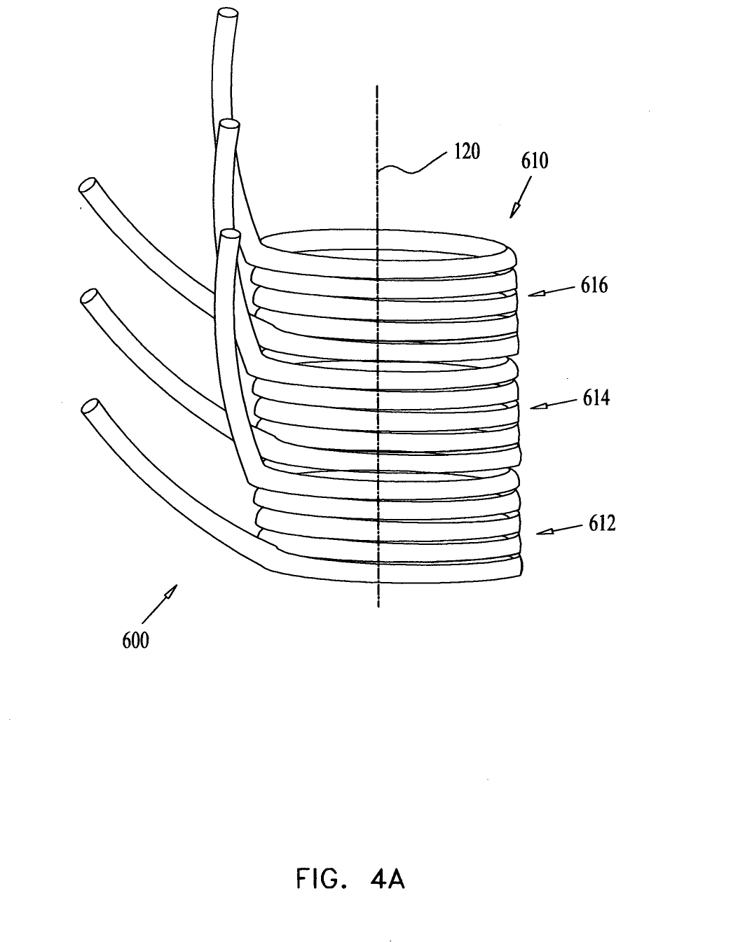

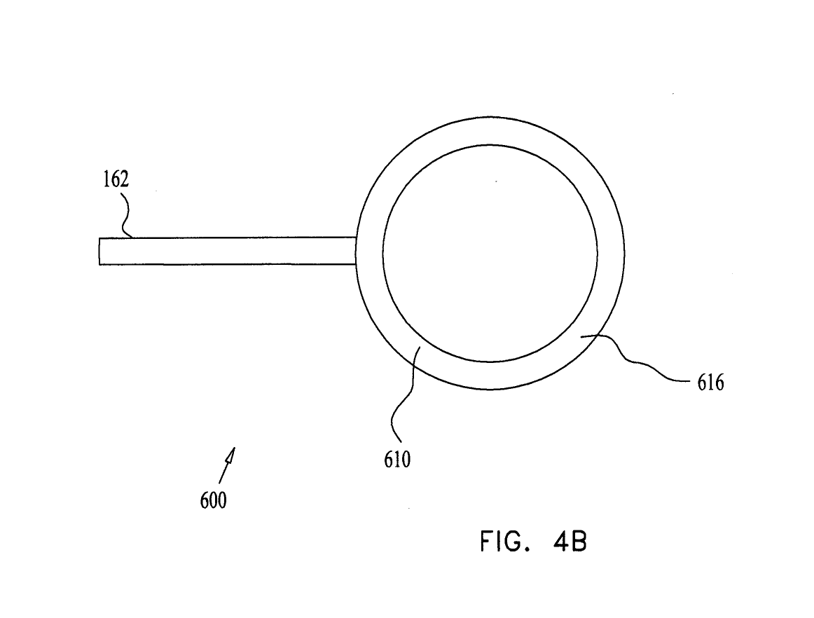

Reference is now made to FIGS. 4A and 4B, which are a simplified pictorial illustration of a solar receiver, constructed and operative in accordance with another embodiment of the present invention and a top view thereof; respectively. As seen in FIGS. 4A and 4B a solar receiver 600 comprises a multiplicity of tubes 610. The tubes 610 may be annularly arranged around the longitudinal central axis 120. Multiplicity of tubes 610 may comprise a plurality of tubular arrays 612, 614 and 616.

Each tubular array may be formed of a tube with a different cross section diameter.

Each tubular array may be formed of a different material. In a non-limiting example, tubular array 612 may be formed of carbon steel, tubular array 614 may be formed of stainless steel and tubular array 616 may be formed of an INCONEL® comprising alloy.

Additionally, a different working fluid may be introduced into each of the tubular arrays 612, 614 and 616. For example, water may be introduced into tubular array 612, oil may be introduced into tubular array 614 and air may be introduced into tubular array 616. The working fluids may be each introduced into the tubular arrays 612, 614 and 616 at a different pressure and/or temperature and/or mass flow rate.

As seen in FIG. 4A, tubular arrays 612, 614 and 616 are mounted upon each other so as to form the solar receiver 600.

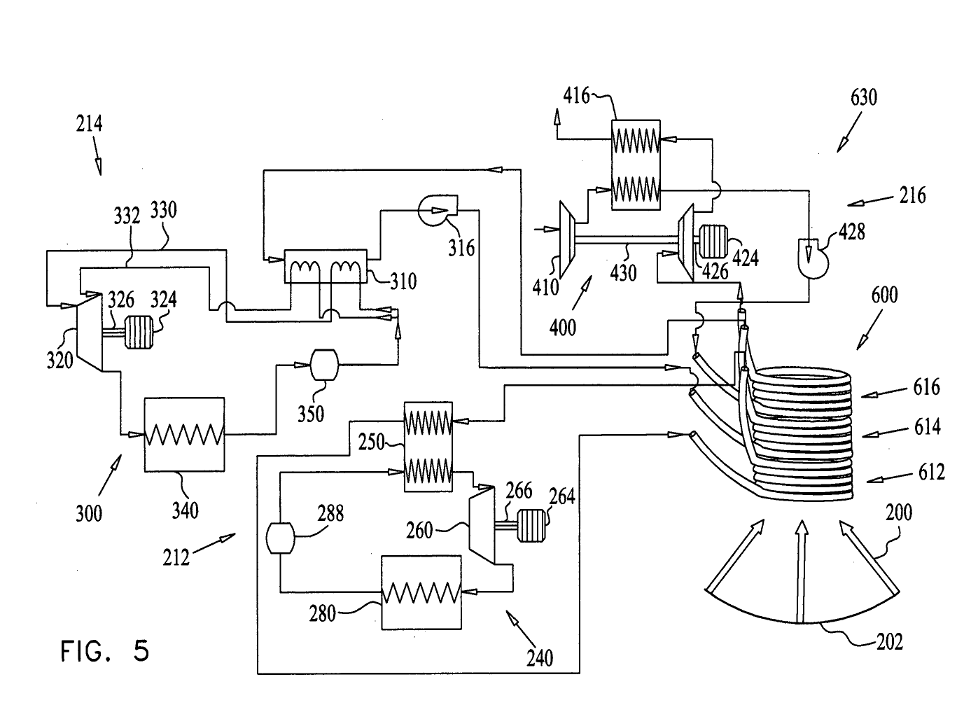

Turning to FIG. 5 it is seen that solar receiver 600 is utilized in a solar thermal energy system 630 similar to the solar thermal energy system 198 of FIG. 2. As seen in FIG. 5, tubular array 612 is in fluid communication with the thermal energy consumption system 212, tubular array 614 is in fluid communication with the thermal energy consumption system 214 and tubular array 616 is in fluid communication with the thermal energy consumption system 216. Each working fluid flowing out of each of arrays 612, 614 and 616 may flow out at a different elevated temperature and thus may be accordingly utilized in respective thermal energy consumption systems 212, 214 and 216 wherein each thermal energy consumption system requires a different fluid temperature for operation thereof.

It is appreciated that tubular arrays 612, 614 and 616 may be in communication with any suitable thermal energy consumption system.

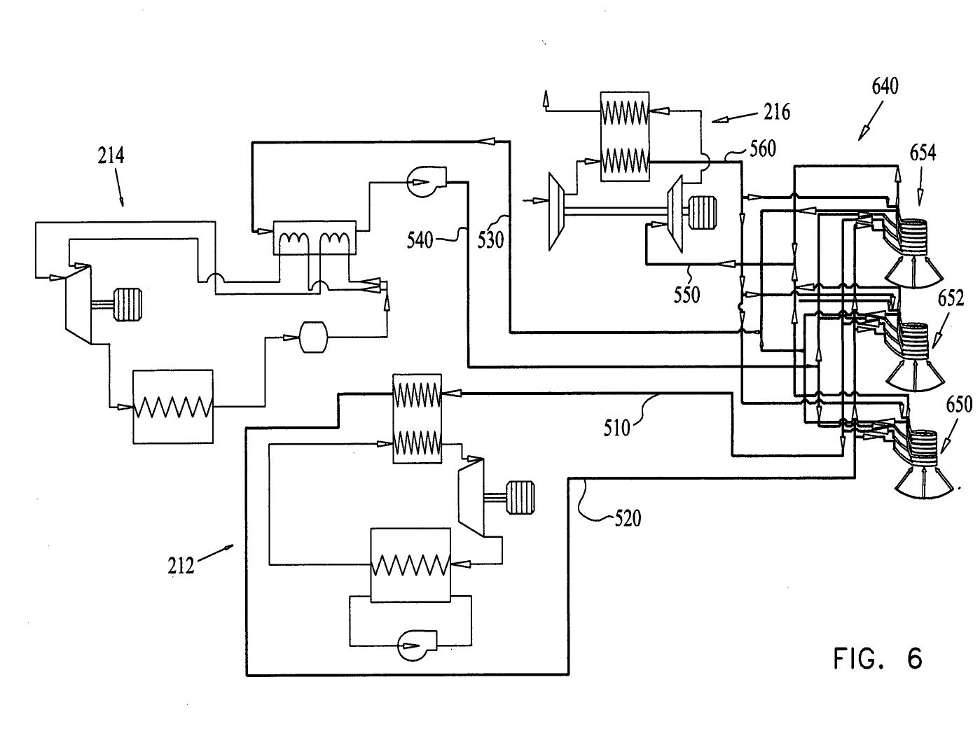

Reference is now made to FIG. 6, which is a simplified schematic illustration of the solar receiver of FIGS. 4A and 4B utilized in another solar thermal energy system 640. As seen in FIG. 6, solar thermal energy system 640 comprises a plurality of receivers which are each in fluid communication with systems 212, 214 and 216. In FIG. 6 three receivers are shown and designated by reference numerals 650, 652 and 654, it being appreciated that many receivers may be in fluid communication with systems 212, 214 and 216.

Each of the tubular arrays 152 of plurality of receivers 650, 652 and 654 are in fluid communication with system 212 via first main duct 510 and second main duct 520. Each of the tubular arrays 154 of plurality of receivers 650, 652 and 654 are in fluid communication with system 214 via first main duct 530 and second main duct 540. Each of the tubular arrays 156 of plurality of receivers 650, 652 and 654 are in fluid communication with system 216 via first main duct 550 and second main duct 560.

It is appreciated that the plurality of receivers may be in fluid communication with any suitable thermal energy consumption system.

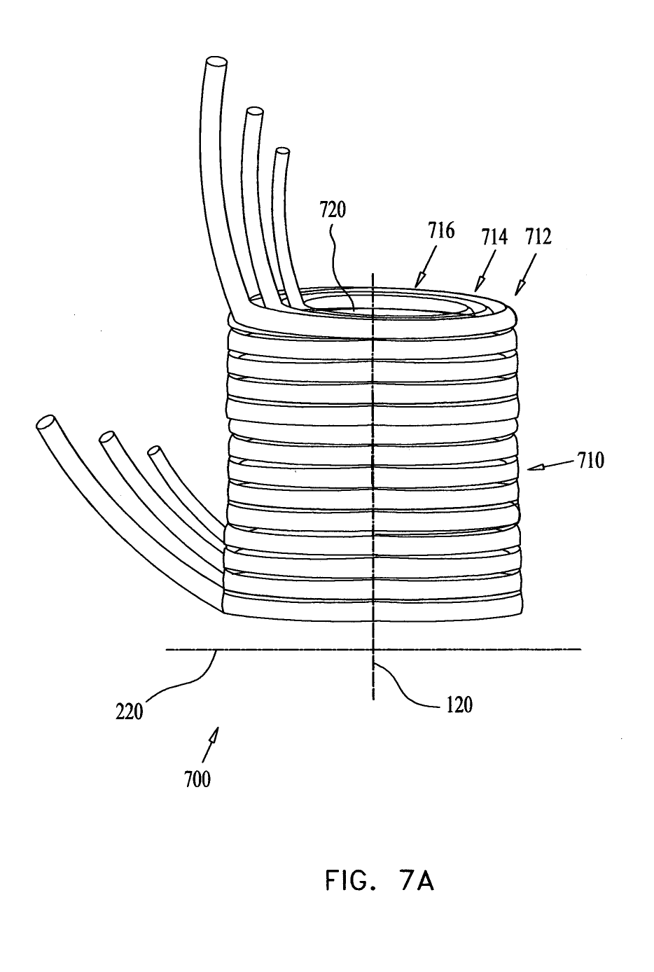

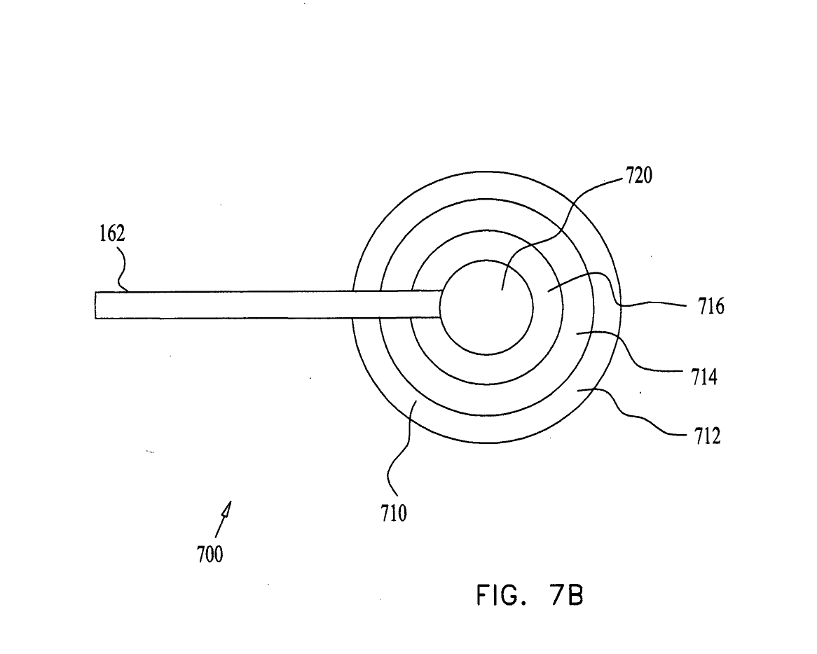

Reference is now made to FIGS. 7A and 7B, which are a simplified pictorial illustration of a solar receiver, constructed and operative in accordance with yet another embodiment of the present invention and a top view thereof, respectively. As seen in FIGS. 7A and 7B, a solar receiver 700 comprises a multiplicity of tubes 710.

The tubes 710 may be annularly arranged around the longitudinal central axis 120. Multiplicity of tubes 710 may comprise a plurality of tubular arrays 712, 714 and 716.

Each tubular array may be formed of a tube with a different cross section diameter.

Each tubular array may be formed of a different material. In a non-limiting example, tubular array 712 may be formed of carbon steel, tubular array 714 may be formed of stainless steel and tubular array 716 may be formed of an INCONEL® comprising alloy.

Additionally, a different working fluid may be introduced into the tubular arrays 712, 714 and 716. For example, water may be introduced into tubular array 712, oil may be introduced into tubular array 714 and air may be introduced into tubular array 716. The working fluids may be each introduced into the tubular arrays 712, 714 and 716 at a different pressure and/or temperature and/or mass flow rate.

As seen in FIGS. 7A and 7B, tubular arrays 712, 714 and 716 are arranged generally concentrically relative to each other, such that tubular array 712 surrounds tubular array 714, which surrounds tubular array 716 and defining a cavity 720 therein.

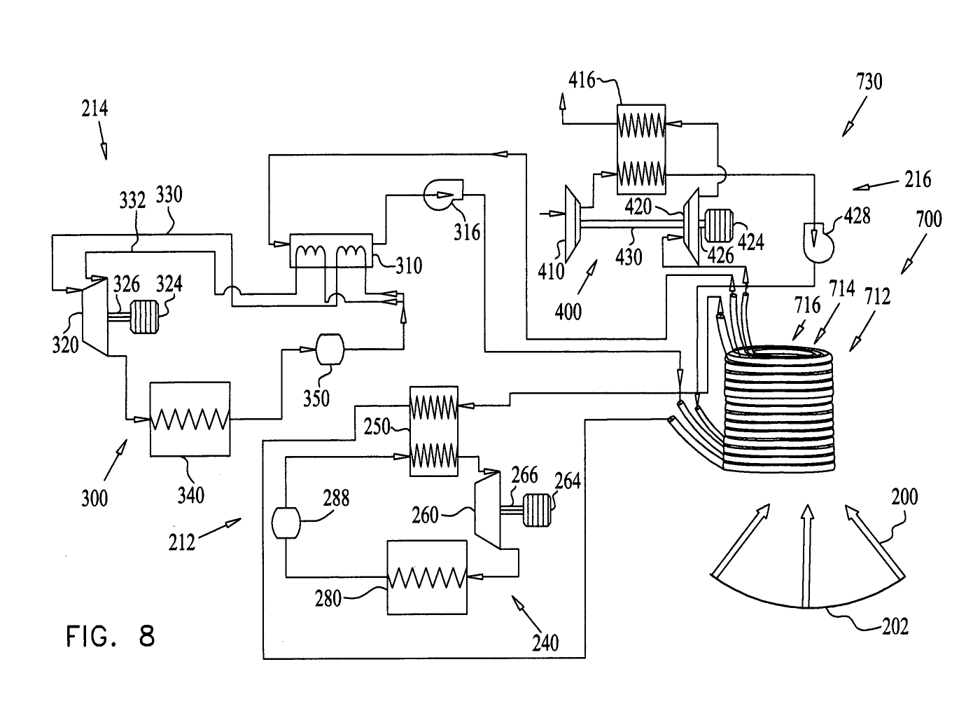

Turning to FIG. 8 it is seen that solar receiver 700 is utilized in a solar thermal energy system 730 similar to the solar thermal energy system 198 of FIG. 2. As seen in FIG. 8, tubular array 712 is in fluid communication with the thermal energy consumption system 212, tubular array 714 is in fluid communication with the thermal energy consumption system 214 and tubular array 716 is in fluid communication with the thermal energy consumption system 216. Each working fluid flowing out of each of arrays 712, 714 and 716 may flow out at a different elevated temperature and thus may be accordingly utilized in respective thermal energy consumption systems 212, 214 and 216 wherein each thermal energy consumption system requires a different fluid temperature for operation thereof.

As described hereinabove, the degree of penetration of solar radiation into tubes 710 follows a Gaussian-like distribution. In other words, as a horizontal distance from the longitudinal axis 120, along a horizontal axis 220, increases, the solar concentration penetrating tubes 110 decreases. Accordingly, the working fluid flowing within tubes 710 is heated to a lesser degree as the horizontal distance of a tube 710 from the longitudinal axis 120 increases. Consequentially, the temperature of a working fluid flowing within a tube 710, distally located on axis 220 from longitudinal axis 120, will rise to a lesser degree than the temperature of working fluid flowing within a tube 710, proximally located on axis 220 to longitudinal axis 120.

Accordingly, the tubes of tubular array 712 are located at a greater horizontal distance to axis 120, wherein the tubes of tubular array 716 are located in horizontal proximity to axis 120. Thus a fluid flowing within tubular array 712 will be heated to a lesser degree than a fluid flowing within tubular array 716. Accordingly, the thermal energy consumption system 212 is preferably a thermal energy consumption system requiring less heat for operating the system 212 than the thermal energy consumption system 216, which preferably is a thermal energy consumption system requiring more heat for operating the system 216. Similarly, the tubes of tubular array 714 are located at a greater horizontal distance to axis 120 than tubular array 716 and at a lesser horizontal distance than the tubes of tubular array 712. Thus a fluid flowing within tubular array 714 will be heated to a lesser degree than a fluid flowing within tubular array 716 and to a greater degree than a fluid flowing within tubular array 712.

It is appreciated that tubular arrays 712, 714 and 716 may be in communication with any suitable thermal energy consumption system.

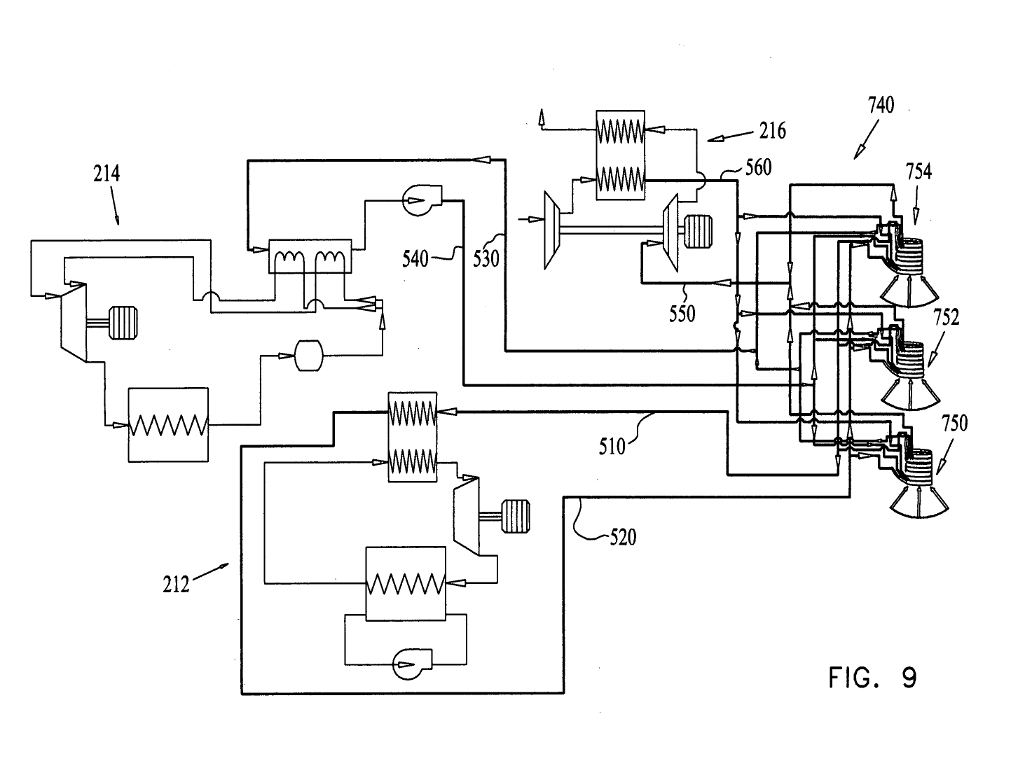

Reference is now made to FIG. 9, which is a simplified schematic illustration of the solar receiver of FIGS. 7A and 7B utilized in another solar thermal energy system 740. As seen in FIG. 9, solar thermal energy system 740 comprises a plurality of receivers which are each in fluid communication with systems 212, 214 and 216. In FIG. 9 three receivers are shown and designated by reference numerals 750, 752 and 754, it being appreciated that many receivers may be in fluid communication with systems 212, 214 and 216.

Each of the tubular arrays 712 of plurality of receivers 750, 752 and 754 are in fluid communication with system 212 via first main duct 510 and second main duct 520. Each of the tubular arrays 714 of plurality of receivers 750, 752 and 754 are in fluid communication with system 214 via first main duct 530 and second main duct 540. Each of the tubular arrays 716 of plurality of receivers 750, 752 and 754 are in fluid communication with system 216 via first main duct 550 and second main duct 560.

It is appreciated that the plurality of receivers may be in fluid communication with any suitable thermal energy consumption system.

It is noted that different types of receivers may be in communication with the thermal energy consumption systems. For example, receiver 100 of FIGS. 1A and 1B may in fluid communication with system 212, receiver 600 of FIGS. 4A and 4B may in fluid communication with system 214 and receiver 700 of FIGS. 7A and 7B may in fluid communication with system 216 or any other suitable type of receiver.

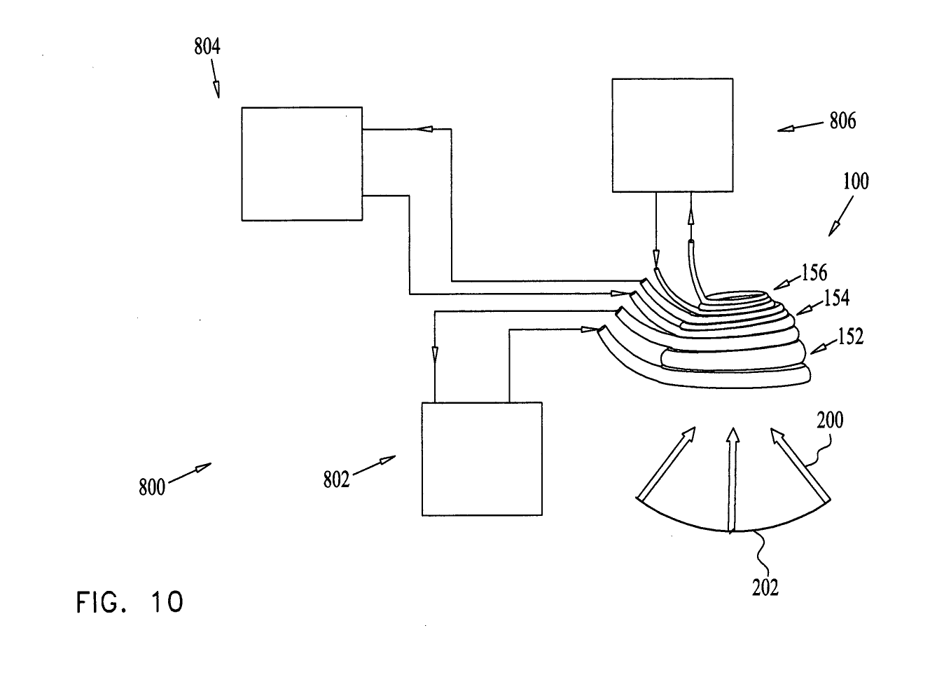

Reference is now made to FIG. 10, which is a simplified schematic illustration of the solar receiver of FIGS. 1A and 1B utilized in still another solar thermal energy system 800. As seen in FIG. 10, tubular array 152 is in fluid communication with a thermal energy consumption system 802, tubular array 154 is in fluid communication with a thermal energy consumption system 804 and tubular array 156 is in fluid communication with the thermal energy consumption system 806. Each working fluid flowing out of each of arrays 152, 154 and 156 may flow out at a different elevated temperature and thus may be accordingly utilized in respective thermal energy consumption systems 802, 804 and 806 wherein each thermal energy consumption system requires a different fluid temperature for operation thereof.

The thermal energy consumption systems 802, 804 and 806 are designated to provide thermal energy for any thermal energy consuming system. In a non-limiting example, thermal energy consumption systems 802, 804 and 806 may provide thermal energy for industrial systems, such as for the food industry. Moreover, the thermal energy may be utilized for vaporization, pasteurization or any other heat consuming process used in the chemical industry or other industries. The thermal energy may be used for drying, such as drying polymer containing products, for example. The thermal energy may be introduced into a vapor turbine for generation of electricity (i.e. electrical energy) therefrom. The thermal energy may be introduced into a gas turbine or any suitable turbine for generation of electricity (i.e. electrical energy)therefrom. Additionally, the thermal energy may be provided to boost a vapor turbine, typically a steam turbine, such as a coal or gas fuel fired steam turbine or a steam turbine included in a combined cycle-gas fired system. Furthermore, the thermal energy may provide vapor to systems consuming vapor, such as steam. The thermal energy may also be utilized for direct heating of a solid desiccant system, such as a desiccant system included in an air conditioning system. The thermal energy may be used for absorption cooling such as by steam or heated air, for example.

It is appreciated that any suitable receiver, such as receiver 600 of FIGS. 4A and 4B or receiver 700 of FIGS. 7A and 7B, may be used in solar thermal energy system 800.

It is appreciated that though the working fluids heated by the receivers of FIGS. 1A-10 are described as being heated by solar radiation impinging upon the receivers, any suitable means for heating the working fluid within the receivers may be provided.

It is noted that according to an embodiment of the invention a receiver may comprise at least two tubular arrays configured in any shape and of any suitable diameter to allow a working fluid to be heated therein.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1-21. (canceled)

22. A solar receiver comprising:
a tubular array including a tube for heating a working fluid flowing therein by solar radiation impinging upon the receiver, said tube being arranged annularly around a central longitudinal axis of said receiver,
said solar radiation having an intensity characterized by a Gaussian-like distribution wherein said intensity is greatest at said central longitudinal axis and said intensity symmetrically receding as a horizontal distance from said central longitudinal axis increases,
said tube being mounted and arranged to define a cavity therein, wherein said cavity is configured in a Gaussian-like curvature;
an inlet for allowing the working fluid to flow into said tube; and
an outlet for allowing heated working fluid to flow out of said tube.

23. A solar receiver according to claim 22 wherein said tubular array comprises a plurality of tubular arrays each including said tube.

24. A solar receiver according to claim 23 wherein each of said tubes of at least more than one of said plurality of tubular arrays is formed with a different cross section diameter.

25. A solar receiver according to claim 23 wherein each of said tubes of at least more than one of said plurality of tubular arrays is formed of a different material.

26. A solar receiver according to claim 23 wherein a different said working fluid flows in each of said tubes of at least more than one of said plurality of tubular arrays.

27. A solar receiver according to claim 23 wherein said working fluid flows in each of said tubes of at least more than one of said plurality of tubular arrays at a different temperature.

28. A solar receiver according to claim 23 wherein said working fluid flows in each of said tubes of at least more than one of said plurality of tubular arrays at a different mass flow rate.

29. A solar receiver according to claim 23 wherein at least one of said plurality of tubular arrays is in fluid communication with a thermal energy consumption system so as to provide said working fluid to said thermal energy consumption system.

30. A solar receiver according to claim 29 wherein thermal energy of said thermal energy consumption system is provided for industrial systems or said thermal energy is utilized for vaporization or pasteurization, or said thermal energy is used for drying, or said thermal energy is used for drying polymer containing products, or said thermal energy is introduced into a vapor turbine for generation of electricity therefrom or said thermal energy is introduced into a gas turbine for generation of electricity therefrom or said thermal energy is provided to boost a vapor turbine, or said thermal energy provides steam and vapor to systems consuming vapor, or said thermal energy is utilized for direct heating of a solid desiccant system, a desiccant system included in an air conditioning system or said thermal energy is used for absorption cooling.

31. A method for heating a working fluid within a solar receiver comprising:
introducing the working fluid into the solar receiver, the solar receiver comprising:
a tubular array including a tube for heating the working fluid flowing therein by solar radiation impinging thereon, said tube being arranged annularly around a central longitudinal axis of said receiver,
said solar radiation having an intensity characterized by a Gaussian-like distribution wherein said intensity is greatest at said central longitudinal axis and said intensity symmetrically receding as a horizontal distance from said central longitudinal axis increases,
said tube being mounted and arranged to define a cavity therein, wherein said cavity is configured in a Gaussian-like curvature; and
heating the working fluid by the solar radiation impinging upon the solar receiver.

32. A solar receiver comprising:
at least more than one tubular array, each of said tubular arrays including:
a tube for heating a working fluid flowing therein by solar radiation impinging upon the receiver;
an inlet for allowing the working fluid to flow in said tube; and
an outlet for allowing heated working fluid to flow out of said tube.

33. A solar receiver according to claim 32 wherein said tube of at least more than one of the tubular arrays is arranged annularly around a central longitudinal axis of said receiver,
said solar radiation having an intensity characterized by a Gaussian-like distribution wherein said intensity is greatest at said central longitudinal axis and said intensity symmetrically receding as a horizontal distance from said central longitudinal axis increases,
said tubes of at least more than one said tubular arrays being mounted together and arranged to define a cavity therein, wherein said cavity is configured in a Gaussian-like curvature.

34. A solar receiver according to claim 32 wherein each of said tube of at least more than one of said plurality of tubular arrays is formed with a different cross section diameter.

35. A solar receiver according to claim 32 wherein said tube of at least more than one of said plurality of tubular arrays is formed of a different material.

36. A solar receiver according to claim 32 wherein a different said working fluid flows in said tube of at least more than one of said plurality of tubular arrays.

37. A solar receiver according to claim 32 wherein said working fluid flows in said tube of at least more than one of said plurality of tubular arrays at a different temperature.

38. A solar receiver according to claim 32 wherein said working fluid flows in said tube of at least more than one of said plurality of tubular arrays at a different mass flow rate.

39. A solar receiver according to claim 32 wherein at least one of said plurality of tubular arrays being in fluid communication with a thermal energy consumption system so as to provide said working fluid to said thermal energy consumption system.

40. A solar receiver according to claim 29 wherein thermal energy of said thermal energy consumption system is provided for industrial systems or said thermal energy is utilized for vaporization or pasteurization, or said thermal energy is used for drying, or said thermal energy is used for drying polymer containing products, or said thermal energy is introduced into a vapor turbine for generation of electricity therefrom or said thermal energy is introduced into a gas turbine for generation of electricity therefrom or said thermal energy is provided to boost a vapor turbine, or said thermal energy provides steam and vapor to systems consuming vapor, or said thermal energy is utilized for direct heating of a solid desiccant system, a desiccant system included in an air conditioning system or said thermal energy is used for absorption cooling.

41. A solar receiver according to claim 32 wherein said tube is arranged annularly around a central longitudinal axis of said receiver, thereby defining a radius extending from said tube to said central longitudinal axis,
and wherein the at least more than one tubular array comprises at least a first and a second tubular array arranged such that said radius of a portion of said tube of said first tubular array being smaller than said radius of a portion of said tube of said second tubular array.

42. A solar receiver according to claim 32 wherein said tube is arranged annularly around a central longitudinal axis of said receiver,
and wherein the at least more than one tubular array comprises at least a first and a second tubular array arranged such that a portion of said tube of said first tubular array being in greater horizontal proximity to said central longitudinal axis than a portion of said tube of said second tubular array,
said horizontal proximity being defined as a distance from said tube to said central longitudinal axis.

43. A method for heating a working fluid within a solar receiver comprising:
introducing the working fluid into the solar receiver, the solar receiver comprising:
at least more than one tubular array, each of said tubular arrays including a tube for heating a working fluid flowing therein by solar radiation impinging upon the receiver; and
heating the working fluid by the solar radiation.

44. A receiver comprising:
at least more than one tubular array, said each tubular array including:
a tube operative to be heated by thermal energy;
an inlet for allowing a working fluid to flow in said tube so as to be heated therein; and
an outlet for allowing said heated working fluid to flow out of said tube.
